(19) United States
(12) Patent Application Publication
(10) Pub. No.: US 2011/0226225 A1
(43) Pub. Date: Sep. 22, 2011

(54) Biased Releasable Connection System

(76) Inventors: Jeffrey James Corsiglia, Toronto (CA); William Kelley, Arroyo Grande, CA (US)

(21) Appl. No.: 12/993,235

(22) PCT Filed: Sep. 3, 2009
(86) PCT No.: PCT/US09/55810

§ 371 Date: Nov. 17, 2010

(51) Int. Cl. F41B 7/00; F16B 21/00

(52) U.S. Cl. 124/16; 403/326; 403/327

(57) ABSTRACT

The present invention is directed to providing a biased releasable connection system that is compact, lightweight, inexpensive and low-power. The system comprises a releasable object that is biased against a retaining mechanism until the connection is released. The system further comprises a small and lightweight shape memory alloy member to actuate the release of the connection. When the connection is released, the biasing mechanism propels the releasable object in a particular direction. The compact design of the system is partly attributable to the strategic utilization and positioning of the shape memory member within the system.

### FIELD

The present invention relates generally to a releasable connection system, and more particularly to a biased releasable connection system comprising a restraining mechanism for restraining a biased releasable object that is actuated by a shape memory alloy member.

### BACKGROUND

Releasable connection devices are used in many applications to releasably connect one object to another object. In some instances, the connection device comprises bias means to urge or propel one object away from the other object once the connection between the two objects is released.

Biased releasable connection systems are known. For example, they can be found in projectile launchers, ejection systems, and electrical connectors to name a few. However, existing biased releasable connection systems are not well suited for applications in which either the size or the weight of the connection system must be minimized. For example, in some applications, the releasable connection system must be compact so as to be installable in a very small space. In other applications, it is the weight of the system that must be limited. Size and weight limitations are generally an issue in the design of, for example, flying objects, and in particular for remote controlled airplanes, helicopters and other flying bodies.

One problem with existing releasable connection systems is that they generally employ a purely mechanical or an electromechanical actuation device to release the connection. In some systems, the release mechanism is activated when an external force is applied to a trigger, typically by a user. The force applied to the trigger is transferred to the release mechanism through one or more levers, cogs or other mechanical components. These components contribute to the overall size, weight and cost of the connection system. Furthermore, systems having a manually operated trigger are not well suited to be operated remotely. As an alternative to a trigger, the release mechanism can be activated by an electromechanical element, which converts an electrical force into a mechanical force. A common type of electromechanical actuator is a solenoid. However, solenoids have a number of drawbacks. They are relatively large and heavy due to their coil. They also have complicated constructions, making them expensive. Furthermore, solenoids generally have a minimum input voltage, and this voltage can be significant. Where the connection system is incorporated into a battery-operated application, the minimum input voltage of the solenoid may be significantly higher than the voltage required to power the rest of the application, thereby necessitating bigger or additional batteries. Therefore solenoids are often not suitable for use in systems that must be compact, lightweight, inexpensive, or low-power.

More recently, shape memory alloy actuators have become an attractive alternative to conventional actuators in certain applications. Shape memory alloy actuators are known in the art. They are metal alloys that possess a number of special characteristics, including the ability to return to their original shape after deformation. This characteristic makes shape memory alloys particularly suitable for use as actuators. Furthermore, shape memory alloy actuators are relatively small and lightweight, and can be inexpensive. Although shape memory alloy actuators are known in the art, they have yet to be efficiently utilized in biased releasable connection systems to reduce the overall size, weight and cost of the systems.

It is therefore desirable to develop a biased releasable connection system comprising a compact, lightweight, inexpensive and low-power actuator.

Another problem with existing biased releasable connection systems is that they generally comprise a biased piston or shuttle to either directly or indirectly propel the releasable object. In some instances, the overall size and weight of the connection system can be reduced if a piston or shuttle is not used. It is therefore also desirable to develop a connection system not having a plunger or a shuttle.

For the foregoing reasons, it can be appreciated that a need exists for an inexpensive, compact, lightweight and low-power biased releasable connection system.

### SUMMARY

The present disclosure provides a biased releasable connection system that addresses the problems described above. The present connection system is a compact, lightweight, inexpensive and low-power system. Such a system can be used in a variety of different applications, and is particularly well suited for use in toys and flying objects to propel or release releasable objects.

While the described embodiment is in the form of a toy projectile launcher, the scope of the present disclosure is not intended to be limited to toy projectile launchers. The present biased releasable connection system can be used for other applications and in other fields, including but not limited to projectile launchers, ejection systems, release systems, electrical connectors, and mechanical connectors.

In one aspect, the present disclosure is directed to a biased releasable connection system comprising a releasable object, a biasing mechanism for exerting a biasing force on the releasable object, a retaining mechanism for retaining the releasable object against the bias of the biasing mechanism, and a release mechanism for releasing the releasable object thereby allowing the biasing mechanism to propel the releasable object from the retaining mechanism, the release mechanism comprising at least one shape memory alloy member for actuating the release.

Another aspect of the present disclosure is directed to a projectile launcher comprising the biased releasable connection system as described herein. In at least one embodiment, the projectile launcher is part of a flying toy.

In a further aspect, the present disclosure is directed to a flying object comprising the biased releasable connection system as described herein. In at least one embodiment, the flying object is a flying toy.

In addition, in at least one embodiment, the shape memory alloy member is strategically disposed in the connection system to provide a compact design.

In at least one embodiment, the actuation force of shape memory alloy member is substantially parallel to the bias force exerted by the biasing mechanism.

Furthermore, in at least one embodiment, the connection system comprises a lever, which cooperates with a shape memory alloy actuator to provide a compact design.

In addition, in at least one embodiment, the connection system comprises a lever to increase the amount of force transferred from the shape memory alloy actuator to the restraining mechanism to release the releasable object.

Furthermore, in at least one embodiment, the biasing mechanism of the connection system propels the releasable object directly without the use of a shuttle.

### BRIEF DESCRIPTION OF THE DRAWINGS

The present disclosure will be better understood having regard to the drawings in which:

FIG. 1 is a perspective view of one embodiment of the biased releasable connection system;

FIG. 2 is a perspective front view of the embodiment shown in FIG. 1;

FIG. 3A is a sectional perspective view of the embodiment shown in FIG. 1 wherein the restraining mechanism is not engaged with the releasable object;

FIG. 3B is a sectional perspective view of the embodiment shown in FIG. 1 wherein the restraining mechanism is engaged with the releasable object;

FIG. 4 is a perspective back view of the support mechanism of the embodiment shown in FIG. 1; and

FIG. 5 is an exploded view of the embodiment shown in FIG. 1.

### DETAILED DESCRIPTION

The present biased releasable connection system is described in one embodiment in the following description with reference to the Figures. While this invention is described in terms of one mode for achieving the objectives of the invention, it will be appreciated by those skilled in the art that variations may be accomplished in view of these teachings without deviating from the scope of the present invention.

The various features and components of the present biased releasable connection system are now described with reference to the Figures.

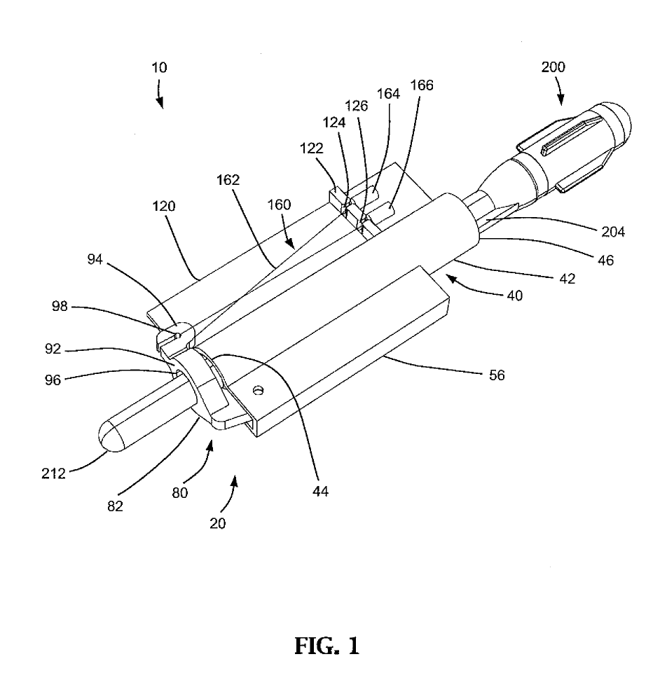

FIGS. 1 to 5 show one embodiment of the biased releasable connection system 10, which comprises a retaining mechanism 20, a biasing mechanism 140, a release mechanism 160, and a releasable object 200.

The retaining mechanism 20 retains the releasable object 200 in position and against the bias of the biasing mechanism 140. The release mechanism 160 releases the releasable object, thereby allowing it to be propelled by the biasing mechanism 140.

### Retaining Mechanism

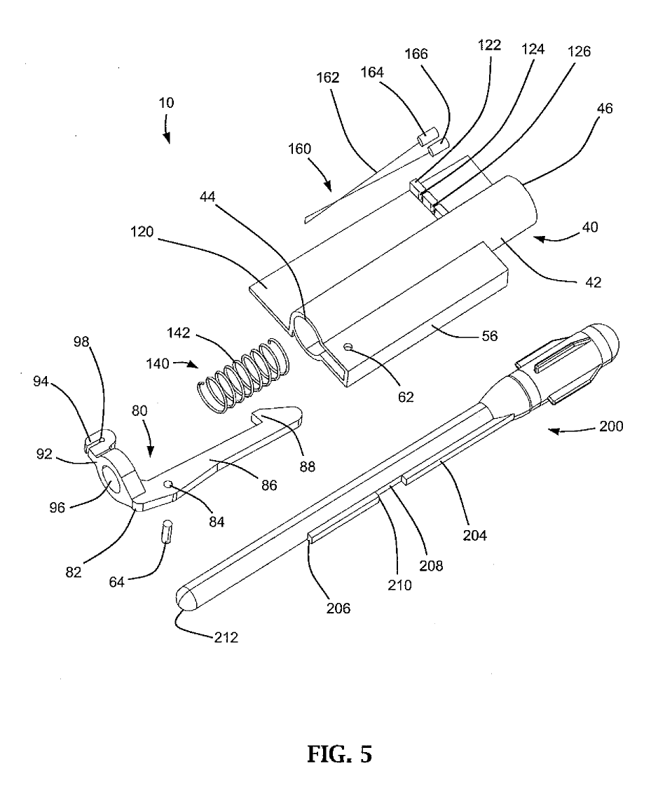

As best shown in FIG. 5, in at least one embodiment, the retaining mechanism 20 comprises a support mechanism 40 for supporting the releasable object 200, and a restraining mechanism 80 for restraining the releasable object 200 against the bias of the biasing mechanism 140.

### Support Mechanism

The support mechanism 40 supports and retains the releasable object 200 in position when forces are exerted on the releasable object 200 by the biasing mechanism 140 and the restraining mechanism 80. The support mechanism 40 can also serve as a launch guide to direct the releasable object 200 in a specific direction once released.

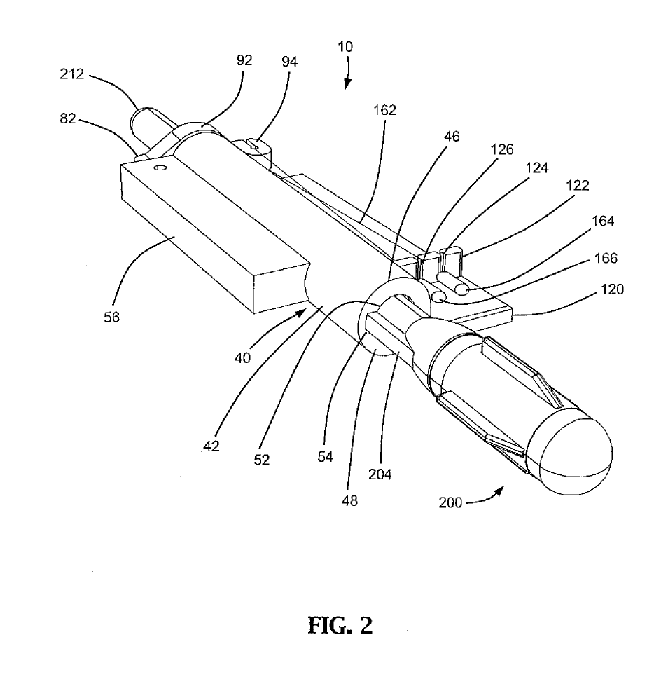

As best illustrated in FIG. 5, in at least one embodiment, the support mechanism 40 comprises a tubular structure 42 having a passageway therethrough, a back end opening 44 and a front end opening 46. The tubular structure 42 can be adapted to receive at least part of the releasable object 200. Having regard to FIG. 2, the front end opening 46 can comprise a guide plate 48, the guide plate 48 having a hole 52 through its centre to receive the releasable object 200. The plate 48 can be formed integrally with the tubular structure 42, or may be a separate piece connected to the tubular structure 42 in any suitable manner known in the art. The plate 48 can be used, for example, to align the releasable object 200 within the tubular structure 42.

### Base

As illustrated in the Figures, in at least one embodiment, the connection system 10 can comprise a base 120. The base 120 can be utilized for any number of functions, including supporting the release mechanism 160, the restraining mechanism 80, or the biasing mechanism 140. The base 120 may also comprise or be cooperable with mounting means (not shown in the Figures) for mounting the system 10 onto another surface or to connect it to some other object. Mounting means can be of any type known in the art. In at least one embodiment, the base 120 is formed integrally with or connected to the support mechanism 40.

### Biasing Mechanism

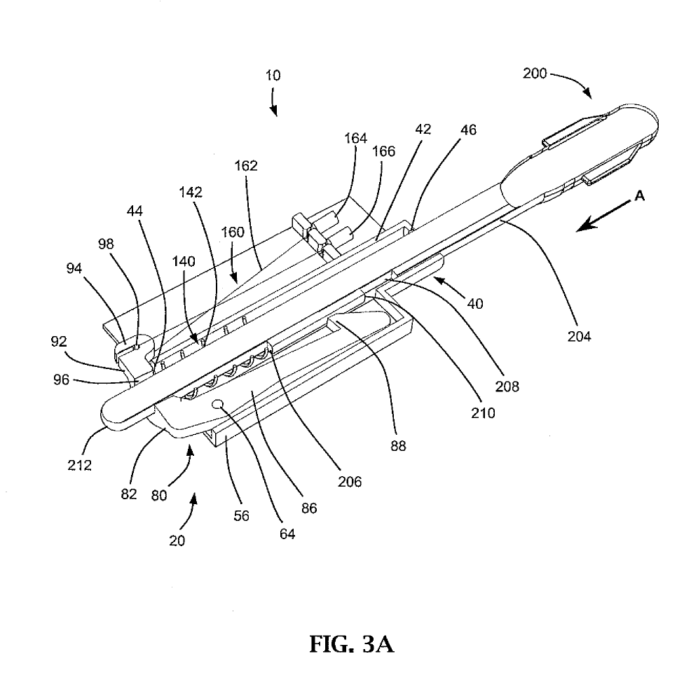

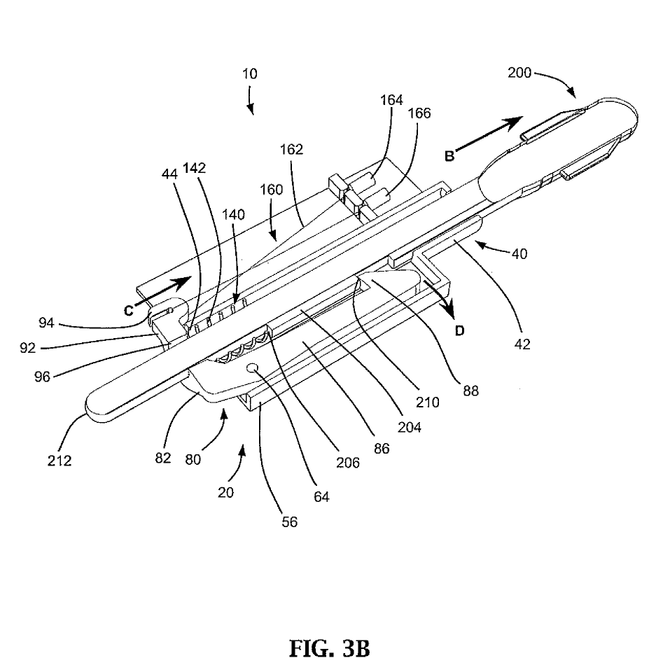

The connection system 10 further comprises a biasing mechanism 140 for biasing the releasable object 200. In at least one embodiment, the biasing mechanism 140 comprises a resilient member to provide a biasing force. As best shown in FIGS. 3A, 3B and 5, in at least one embodiment, the resilient member is a coil spring 142, which biases the releasable object 200 in the direction of arrow B (see FIG. 3B). However, this is not intended to be limiting and those skilled in the art will appreciate that one or more resilient members of varying types, shapes, lengths and strengths can be used depending on the requirements of the given application. The resilient member can be made of metal, natural or synthetic elastomer, or any other suitable material.

As illustrated in FIGS. 3A and 3B, coil spring 142 can be disposed within the tubular structure 42 of the support mechanism 40. The diameter of the spring 142 is best chosen such that the spring 142 can accommodate the releasable object 200, but can also expand and contract freely within the tubular structure 42. The releasable object 200 is moved into a cocked position, or “loaded”, by inserting the back end 212 of the releasable object 200 into the front end opening 46 of the tubular structure 42. As the releasable object 200 is slid toward the back end opening 44 of the tubular structure 42 in the direction of arrow A (see FIG. 3A), a first mating surface 206 of a spline 204 on the releasable object 200 contacts and engages the spring 142. As the releasable object 200 is moved even further in the direction of the back end opening 44, the spring 142 is compressed (see FIG. 3B).

As shown in FIGS. 3A and 3B, in at least one embodiment, the releasable object 200 directly contacts the biasing mechanism 140. The first mating surface 206 of the releasable object 200 contacts and engages the spring 142. In one or more other embodiments, the connection system 10 can further comprise a shuttle (not shown in the Figures) that is disposed between the resilient member and the releasable object 200. The shuttle can be connected to or disposed proximate the resilient member such that the releasable object 200 contacts the shuttle rather than the resilient member as the releasable object 200 is loaded into position. The shuttle can be an annular shuttle, a piston, a plunger, or any other suitable type of shuttle.

The back end opening 44 of the tubular structure 42 can be at least partially obstructed to prevent the spring 142 from being pushed out of the back end opening 44 when the releasable object 200 is moved into the cocked position. As best seen in FIG. 3B, the back end opening 44 can be partially obstructed by the restraining mechanism 80, and in particular by the effort arm 92 of the lever 82. However, the spring 142 can also be connected to the tubular structure 42 in order to retain it substantially within the structure 42 by well known methods, including but not limited to entrapping or hooking the end of the spring 142 into a molded feature in structure 42. Furthermore, the releasable object 200 can extend beyond the back end opening 44 of the tubular structure 42 (see FIGS. 1, 3A and 3B). In at lease one embodiment, this is achieved by providing a passageway 96 in the effort arm 92 of the lever 82 to allow the releasable object 200 to extend therethrough.

### Restraining Mechanism

Connection system 10 also comprises a restraining mechanism 80 for restraining the releasable object 200 in the cocked position against the bias of the biasing mechanism 140. FIG. 3B shows one embodiment of the connection system 10 in which the releasable object 200 is in the cocked position.

In at least one embodiment, the restraining mechanism 80 comprises a movable mechanical obstruction to engage and thereby restrain the releasable object 200. As best illustrated in FIGS. 3A, 3B and 5, the restraining mechanism 80 can comprise a pivoting lever 82. The lever 82 can further comprise a latch arm 86 and an effort arm 92, the latch arm 86 for engaging the releasable object 200 and the effort arm 92 for cooperating with the release mechanism 160. In the embodiment shown in the Figures, the angle between the latch arm 86 and the effort arm 92 is approximately 90 degrees. However, it will be apparent to those skilled in the art that other angles may also be suitable depending on the particular application.

As illustrated in FIG. 5, the lever 82 can also comprise a pin aperture 84 for receiving a pivot pin 64, which cooperates with pin holes or indentations 62 in the latch arm housing 56. Furthermore, the latch arm 86 can comprise a latch hook 88 for engaging the second mating surface 210 on the spline 204 of the releasable object 200. The second mating surface 210 is defined by a recess 208 in the spline 204. FIG. 3B shows the latch hook 88 engaged with second mating surface 210 on the releasable object 200.

In at least one embodiment, as the releasable object 200 is moved from an uncocked position (FIG. 3A) into the cocked position (FIG. 3B), the releasable object 200 contacts and applies a compression force on the spring 142. Part of this force compresses the spring 142 and part of the force is transferred through the spring 142 to the effort arm 92 of the lever 82, which causes the lever 82 to rotate about pin 64. This rotation swivels the effort arm 92 away from the tubular structure 42 and the latch arm 86 towards the releasable object 200 causing the latch hook 88 to engage the second mating surface 210 on the releasable object 200. The latch arm 86 and hook 88 then hold the releasable object 200 against the compressed spring 142 (FIG. 3B). Furthermore, as shown in FIG. 2, the front end opening 46 of the tubular structure 42 can comprise a keyway 54. The spline 204 on the releasable object 200 can serve as a key to ensure proper alignment of the spline 204 and second mating surface 210 with the latch arm 86 and the latch hook 88.

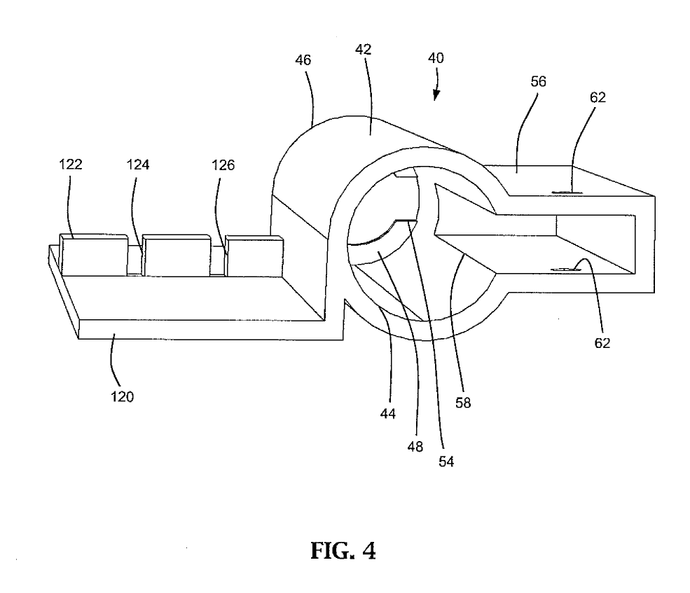

As illustrated in FIGS. 3A and 3B, the lever 82 can be pivotally connected to the housing 56. The lever 82 can be connected to the housing 56 by a pin 64, the pin 64 extending through the pin aperture 84 in the lever 82. The latch arm 86 of the lever 82 can be protected by housing 56 and can be rotated from the housing 56 into the inner portion of the tubular structure 42 through the longitudinal opening 58 in the tubular structure 42 (FIG. 4) to engage the releasable object 200.

The restraining mechanism 140 can be made of plastic or any suitable material known in the art.

### Release Mechanism

The connection system 10 further comprises a release mechanism 160 for releasing the releasable object 200 from the cocked position, thereby allowing it to be propelled by the biasing mechanism 140. The release mechanism 160 comprises at least one shape memory alloy member 162, which produces an actuation force when heated above its transitional temperature. This actuation force causes the restraining mechanism 80 to disengage the releasable object 200 thereby allowing the biasing mechanism 140 to propel the releasable object 200.

As shown in the Figures, in at least one embodiment, the shape memory alloy member 162 of the release mechanism 160 is a wire, which contracts along its length when heated above its transition temperature. The ends of the wire can be coupled to electrical leads 164 and 166, which can serve both as electrical contact points and anchor points. In operation, when the releasable object 200 is to be released, the shape memory alloy member 162 is heated above its transition temperature by any suitable means. When the shape memory alloy member 162 reaches its transition temperature, it contracts along its length, thereby exerting a pull force on the effort arm 92 of lever 82. This pull force causes the lever 82 to pivot, pulling the effort arm 92 towards the support mechanism 40 and pivoting the latch arm 86 away from the releasable object 200. This causes the latch hook 88 to disengage the releasable object 200, thereby allowing the biasing mechanism 140 to propel the releasable object 200.

As best illustrated in FIGS. 1 and 2, in at least one embodiment, the shape memory alloy member 162 is connected to the restraining mechanism 80 and is anchored to one or more anchor positions. More specifically, the shape memory alloy member 162 is connected to a first electrical lead 164, to the hook 94 on the effort arm 92 of the lever 82, and to a second electrical lead 166. The shape memory alloy member 162 is wound around the hook 94 such that it resides in the throat 98 of the hook 94. The alloy member 162 can be anchored to one or more parts of the retaining mechanism 20, such as the support mechanism 40, the housing 56, or the base 120. In at least one embodiment, shape memory alloy member 162 is anchored to the base 120 by the leads 164 and 166. The leads 164 and 166 can be disposed on the base 120 behind an obstruction such as wall 122, the wall 122 serving to oppose the contraction force of the alloy member 162. The wall 122 can comprise slots 124 and 126 to allow the shape memory alloy 162 to pass therethrough.

As previously described, in at least one embodiment, the shape memory alloy member 162 is in the form of a wire that contracts along its length. Shape memory alloy wires that contract along their lengths typically do so by a specific percentage of their length, which is generally no greater than 10 percent. Therefore the length of such a wire is generally several times greater than the length of its stroke (i.e. distance by which it contracts). Depending on the desired stroke length, this can necessitate a relatively long shape memory alloy wire. The compact design of the present connection system 10 is partly attributable to the strategic positioning of the shape memory alloy member 162 relative the other components of the connection system 10. As can be seen in FIG. 3B, in at least one embodiment, the shape memory alloy member 162 is disposed such that its actuation force is exerted in a direction (indicated by arrow C) that is substantially parallel to the force exerted by the biasing mechanism 140 (indicated by arrow B). Positioning the longitudinal axis of the alloy member 162 close to and substantially parallel with the longitudinal axis of the support mechanism 42 can allow for a more compact design than if the alloy member 162 was not positioned parallel to the direction of the biasing force. Furthermore, such positioning can permit for a relatively lengthy actuation stroke without increasing the overall size of the connection system 10.

Furthermore, the compact design of the present invention results from, in at least one embodiment, the use of the shape memory alloy member 162 in conjunction with a lever to release the releasable object 200. In particular, the direction of the actuation force produced by the shape memory alloy member 162 can be changed using, for example, a simple component such as an angular lever. Therefore the direction of the force needed to disengage the restraining mechanism 80 from the releasable object 200 need not be the same as the direction of the force produced by the shape memory alloy actuator 162. As best illustrated in FIG. 3B, in at least one embodiment of the present invention, the lever 82 of the restraining mechanism 80 is an angular lever. The angular lever changes the direction of the force and motion produced by the shape memory alloy member 162 (arrow C) to a direction that can be used to disengage the latch hook 88 from the releasable object 200 (arrow D).

In addition to changing the direction of a force or motion, a lever can also be used to obtain a mechanical advantage. This can be useful in producing a sufficient amount of force to overcome the static friction between the latch hook 88 and the second mating surface 210 of the releasable object 200. It will be apparent to a person skilled in the art how to change the mechanical advantage of the lever by changing the lengths of the latch arm 86 and effort arm 92.

Shape memory alloys are known in the art and are readily available. A defining characteristic of a shape memory alloy is that it changes shape when heated above its transition temperature. Without being bound by theory, this change in shape is the result of a molecular realignment, the energy for which comes from the heat applied to the alloy. The transition temperature of a shape memory alloy is the temperature at which the alloy changes from the Martensite phase to the Austenite phase. To start, an alloy is heated into its Austenite phase and then formed into a given shape (the “original” shape). The alloy is then cooled and allowed to change into its Martensite phase. At this point, the shape memory alloy can be deformed by, for example, being stretched or bent by some external force. When heated again above its transition temperature, the alloy changes into its Austenite phase, which returns it to its original shape.

In at least one embodiment, the shape memory alloy member 162 is deformed by being stretched along its length. This stretching occurs when the releasable object 200 is moved into the cocked position. As previously described, when the releasable object 200 is loaded into the cocked position, some of the force transferred to the spring 142 from the releasable object 200 is transferred to the effort arm 92 of the lever 82, thereby causing the effort arm 92 and thus the hook 94 to rotate away from the tubular structure 42. This stretches the shape memory alloy member 162 along its length. Then, when the shape memory alloy member 162 is heated above its transition temperature, the alloy member 162 contracts to its original length from its stretched length. The force generated by this contraction pulls the effort arm 92 towards the tubular structure 42, which causes the latch arm 86 and latch hook 88 to rotate away from the releasable object 200 thereby disengaging the releasable object 200, which is then propelled by the biasing force of the biasing mechanism 140.

The shape memory alloy member 162 is heated by any suitable means known in the art. In at least one embodiment, a power source, which is not shown in the Figures, can be electrically coupled to the alloy member 162 through leads 164 and 166. The power source can be any suitable power source that is capable of providing sufficient power to the shape memory alloy member 162 to heat it above its transition temperature. Some shape memory alloy actuators can be activated with less power than comparable solenoids. In addition to the power source, suitable means can be utilized to control the type, amount and timing of the power supplied to the shape memory alloy member 162. Furthermore, the supply of power to the alloy member 162 can be activated by any suitable means, including but not limited to a user-initiated signal transmitted through a wired or wireless transmission medium.

In addition, in at least one embodiment, the shape memory alloy member 162 is disposed externally to the exterior surface of the biased releasable connection system 10. This permits the alloy member 162 to be cooled by surrounding air, and thus may eliminate the need for a heat sink.

Those skilled in the art will recognize that the shape memory alloy member 162 can have any suitable shape, including but not limited to that of a strip, ribbon, coil, tube, or sheet. Furthermore, the release mechanism 160 of the present connection system 10 is not limited to a single shape memory alloy member; it can comprise a plurality of shape memory alloy members, which can be arranged in any suitable configuration.

The shape memory alloy member 162 can be made of any suitable shape memory alloy known in the art. These include but are not limited to shape memory alloys made of nickel-titanium (NiTi), iron-manganese-silicon (FeMnSi), copper-aluminum-nickel (CuAlNi), and copper-zinc-aluminum (CuZnAl).

The previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A biased releasable connection system comprising:
a releasable object;
a biasing mechanism for exerting a biasing force on the releasable object;
a retaining mechanism for retaining the releasable object in a cocked position against the bias of the biasing mechanism; and
a release mechanism for releasing the releasable object from the cocked position thereby allowing the biasing mechanism to propel the releasable object from the retaining mechanism, the release mechanism comprising at least one shape memory alloy member for actuating the release;
wherein the shape memory alloy member exerts a force in a direction that is substantially parallel to the direction of the biasing force exerted by the biasing medium.

2. The biased releasable connection system of claim 1, wherein the retaining mechanism comprises a support mechanism for supporting the releasable object.

3. The biased releasable connection system of claim 2, wherein the support mechanism comprises a tubular structure, the tubular structure adapted to receive at least part of the releasable object.

4. The biased releasable connection system of claim 3, wherein at least part of the biasing mechanism is disposed within the tubular structure.

5. The biased releasable connection system of claim 2, wherein the releasable object comprises a key and the support mechanism comprises a keyway for receiving the key.

6. The biased releasable connection system of claim 2, wherein the support mechanism has a first end and a second end, the biasing mechanism biasing the releasable object towards the first end, wherein the releasable object extends beyond the second end of the support mechanism when in the cocked position.

7. The biased releasable connection system of claim 1, wherein the biasing mechanism comprises a resilient member for providing a biasing force.

8. (canceled)

9. (canceled)

10. (canceled)

11. The biased releasable connection system of claim 7, wherein the resilient member is a spring.

12. The biased releasable connection system of claim 1, wherein the retaining mechanism comprises a restraining mechanism for restraining the releasable object against the biasing force of the biasing mechanism.

13. The biased releasable connection system of claim 12, wherein the restraining mechanism comprises a moveable mechanical obstruction for engaging and restraining the releasable object, the release mechanism producing an actuation force that disengages the movable mechanical obstruction, thereby allowing the biasing mechanism to propel the releasable object.

14. The biased releasable connection system of claim 13, wherein the movable mechanical obstruction is a lever.

15. The biased releasable connection system of claim 14, wherein the lever comprises an effort arm and a latch arm, the latch arm engaging and restraining the releasable object, and wherein the actuation force produced by the release mechanism acts on the effort arm to pivot the lever causing the latch arm to disengage the releasable object.

16. The biased releasable connection system of claim 14, wherein the lever of the restraining mechanism is an angular lever.

17. (canceled)

18. The biased releasable connection system of claim 1, wherein at least part of the shape memory alloy member is disposed externally to the exterior surface of the biased releasable connection system.

19. The biased releasable connection system of claim 1, wherein the shape memory alloy member contracts along its length when heated above its transition temperature.

20. The biased releasable connection system of claim 1, wherein the shape memory alloy member is a shape memory alloy wire.

21. The biased releasable connection system of claim 1, wherein the shape memory alloy member comprises nickel and titanium.

22. The biased releasable connection system of claim 1, wherein the releasable object is a projectile.

23. A projectile launcher comprising the biased releasable connection system of claim 1.

24. A flying object comprising the biased releasable connection system of claim 1.
